(19) United States
(12) Patent Application Publication
(10) Pub. No.: US 2008/0216787 A1
(43) Pub. Date: Sep. 11, 2008

(54) Method for starting an internal combustion engine

(76) Inventors: Karsten Kroepke, Ludwigsburg (DE); Jens Wolber, Gerlingen (DE); Ruediger Weiss, Moetzingen (DE); Martin Streib, Vaihingen (DE); Niraimathi Appavu Mariappan, Freiburg im Breisgau (DE); Karl-Bernhard Lederle, Rutesheim (DE); Jean-Marc Tonye Djon, Stuttgart (DE); Pierre-Yves Crepin, Stuttgart (DE); Matthias Walz, Vaihingen/Enz (DE); Manfred Dietrich, Markgroeningen (DE)

Correspondence Address: KENYON & KENYON LLP, ONE BROADWAY, NEW YORK, NY, 10004, US

(21) Appl. No.: 11/897,601

(22) Filed: Aug. 29, 2007

(30) Foreign Application Priority Data
Aug. 29, 2006 (DE) 10 2006 040339.8

(51) Int. Cl. F02N 17/00

(52) U.S. Cl. 123/179.3

(57) ABSTRACT

To achieve a reliable and exhaust-optimized combustion starting already from the beginning of a combustion phase in the startup of an internal combustion engine, the internal combustion engine is brought to a target speed by an electric motor in a drag phase, the target speed being higher than the previously known starting speed. The target speed corresponds approximately to an idling speed assigned to the internal combustion engine, for example. After exceeding the starting speed, first a mixture enrichment is determined, taking into account a prevailing state of a wall film here in particular. Only after reaching the target speed is the fuel metered and does the combustion take place in the combustion phase. The fuel is metered here in particular on the basis of the mixture enrichment determined after exceeding the starting speed.

### FIELD OF THE INVENTION

The present invention relates to a method for starting an internal combustion engine, in which an electric motor is activated after a shut-down phase and the internal combustion engine is brought to a starting speed by the electric motor. The present invention also relates to an internal combustion engine as well as a control unit for controlling and regulating an internal combustion engine; an electric motor provided for the internal combustion engine is activatable after a shut-down phase and is capable of inducing a starting speed in the internal combustion engine. The present invention also relates to a computer program capable of running on a computer, in particular a control unit for controlling and regulating an internal combustion engine.

### BACKGROUND INFORMATION

Internal combustion engines may be started by using an electric motor known as a starter to bring the internal combustion engine to a starting speed. The power to be delivered by the electric motor for reliable starting of the internal combustion engine depends on the design of the electric motor, the efficiency of the automotive battery available and in particular the starting speed. To minimize the electric power required for startup and to also minimize the weight of the starter system, which is determined decisively by the efficiency of the automotive battery and the electric motor, the starting speed selected is significantly below the idling speed above which controlled and regulated automatic operation of the internal combustion engine is reliably possible and a torque suitable as the basis for implementation of additional torque demands is generated.

The starting speed is usually just so selected that reliable starting of the internal combustion engine—i.e., operation of the internal combustion engine on the basis of its own combustion power—is possible. In a gasoline engine, the starting speed is often on the order of magnitude of 100 revolutions per minute and in diesel engines it is on the order of 200 revolutions per minute, whereas the idling speed is between 600 and 800 revolutions per minute, for example.

For reliable operation of an internal combustion engine, a plurality of input parameters is detected, analyzed by a control unit and taken into account in controlling and regulating the internal combustion engine; this includes in particular the functions of mixture formation and ignition. During the starting phase, the internal combustion engine is usually operated according to a pre-control program on the basis of the particularly high rotational speed dynamics in the starting phase and the poorly detectable operating conditions until reaching the idling speed. For example, the position of the throttle valve, the fuel quantity and the ignition points in time are preselected here using engine characteristics maps. A torque structure which takes into account the determination and analysis of a torque demand is not active in the starting phase. Only after the end of the starting phase is it possible for the torque of the internal combustion engine to be set as a function of the driver's intent, for example.

During operation of the internal combustion engine, a certain quantity of fuel, the so-called wall film, is deposited in the combustion chambers of the internal combustion engine. If an intake manifold is allocated to the internal combustion engine and if the fuel is metered via intake manifold injection, then a wall film is also deposited on the inside walls of the intake manifold. The wall film behaves like a fuel reservoir, first withdrawing fuel from a metered air-fuel mixture and then releasing it again.

The wall film evaporates during a shut-down phase of the internal combustion engine. To prevent the air-fuel mixture from becoming lean during the first operating cycles in the starting phase and to ensure reliable combustion, the proportion [of fuel] in the air-fuel mixture is increased at first at least briefly for this reason. This is referred to as enrichment of the mixture. This achieves the result that fuel may be deposited on the walls of the intake manifold or the combustion chambers while nevertheless a portion of the fuel in the air-fuel mixture remains available for combustion.

For the reasons given above, the enrichment of the mixture is also pre-controlled during the starting phase. However, this pre-control has the disadvantage that the air-fuel mixture is frequently suboptimal, prolonging the starting phase on the one hand while also increasing fuel consumption on the other. In particular, exhaust-optimized combustion is not usually possible in the starting phase, resulting in undesirably high emissions in the exhaust.

### SUMMARY OF THE INVENTION

An object of the exemplary embodiments and/or exemplary methods of the present invention is to create a possibility for reliable exhaust-optimized combustion from the very start of the combustion phase.

This object is achieved by a method of the type defined in the introduction by bringing the internal combustion engine to a target rotational speed using the electric motor in a drag phase wherein the target speed is above the starting speed.

The target speed here corresponds approximately to the idling speed, for example. If the internal combustion engine is started by an electric motor, there is initially no injection or combustion on reaching the starting speed known in the related art. Instead, an enrichment of the mixture is determined first after exceeding the starting speed, the prevailing status of the wall film being taken into account here in particular. Only on reaching the target speed do fuel metering and combustion take place in a combustion phase. Fuel is metered here in particular taking into account the enrichment of the mixture determined after exceeding the starting speed.

With the method according to the present invention, the internal combustion engine is consequently brought to a much higher rotational speed—the target speed—during a start than was possible in the past, and combustion is started only on reaching this significantly higher speed. With an appropriate design of the electric motor, the target speed may be reached rapidly in particular, so that a faster start is feasible on the whole. Furthermore, the steady-state target speed allows operating conditions to be detectable and analyzable so that an improved determination of the enrichment of the mixture is possible.

Enrichment of the mixture may be determined as a function of the measured duration of the shut-down phase. Since the wall film evaporates during the shut-down phase of the internal combustion engine, it is possible to determine any wall film that might still be present for a known duration of the shut-down phase and to take it into account in enriching the mixture.

Alternatively or additionally, the duration of the drag phase, the target speed and/or a measured temperature may also be taken into account in determining the enrichment of the mixture. These operating parameters have an influence on the reduction of the wall film and thus permit a particularly precise determination of the enrichment of the mixture which is necessary to compensate for the wall film effect.

During the drag phase, air is passed through the intake manifold and the combustion chambers without any fuel being injected. The wall film is consequently reduced as a function of the duration of the drag phase. Taking into account the target speed, it is possible to ascertain the quantity of air flowing through the intake manifold and the combustion chambers during the drag phase and thus accelerating the reduction of the wall film. In this way, the reduction of the wall film may be determined again with even greater accuracy.

The reduction of the wall film also depends on the temperature of the internal combustion engine because evaporation of fuel is greater at higher temperatures. This may be taken into account in determining the prevailing temperature of the internal combustion engine. For example, the temperature of the motor oil or the water coolant may be used as the basis here.

According to an embodiment of the method according to the present invention that is particularly easy to implement, the enrichment of the mixture is determined as the maximum possible value. The combustion phase is thus begun initially with the maximum possible enrichment of the mixture. This ensures that the wall film is built up particularly rapidly.

In determining the enrichment of the mixture, a prevailing torque demand may be taken into account. Since the combustion phase begins only on reaching the target speed, at which point in time the operating conditions are detectable, a prevailing torque demand may be detected, e.g., by analysis of a signal supplied by a pedal value sensor. If there is a high torque demand, an even greater enrichment of the mixture may be determined, this in turn ensuring a rapid buildup of the wall film, while on the other hand supplying the required high fuel ratio in the air-fuel mixture for implementing the high torque demand.

According to an exemplary embodiment of the method according to the present invention, the enrichment of the mixture in the combustion phase is decreased continuously or in increments. Operating parameters that influence the buildup of the wall film may be detected and taken into account. These include in particular the prevailing value of the enrichment of the mixture, the target speed, the prevailing speed detected, the duration of the combustion phase, the prevailing torque, and/or the prevailing temperature of the internal combustion engine. This makes it possible to ensure that the enrichment of the mixture on the one hand allows the fastest possible buildup of the wall film while on the other hand the enrichment of the fuel is decreased as a function of the thickness of the wall film already built up, so that there is no unnecessary metering of fuel which is not needed for further buildup of the wall film or for combustion.

According to another advantageous embodiment of the method according to the present invention, the target speed is not fixedly predetermined but instead is ascertained as a function of a prevailing vehicle electrical system voltage, a prevailing torque demand, a temperature detected in the internal combustion engine and/or the measured duration of the shut-down phase. This allows a further improvement in the starting performance of the internal combustion engine, taking into account differences in operating parameters. For example, if the prevailing vehicle electrical system voltage is particularly low, it is possible that the power required to achieve a predetermined target speed may not be available from the automotive battery. To nevertheless ensure reliable starting of the internal combustion engine, the target speed may be lowered, so that it is achievable with the available vehicle battery power. It is possible in particular to then provide for the engine to be started in the traditional manner, with the internal combustion engine being accelerated by the electric motor only until reaching the starting speed.

The target speed may be selected to be higher than the idling speed. This is advantageous in particular if the internal combustion engine is operable in a so-called coasting mode. In this case, for startup of the internal combustion engine and in particular for metering of fuel and enrichment of the mixture, it is possible to rely on individual parts of methods that are already used in the control unit for implementing reinstatement after the end of the coasting mode. The method according to the present invention may be used to advantage in particular when the internal combustion engine and the electric motor are intended to work together in a hybrid drive because in a hybrid drive, strategies for a reinstatement after a coasting phase are already implemented in a hybrid drive on the one hand, while on the other hand the electric motor is designed so that the target speed required for implementing the method according to the present invention is achievable with no problem.

This object is also achieved by a control unit and by an internal combustion engine of the type defined previously, so that the control unit or the internal combustion engine is equipped to implement the method according to the present invention.

This object is also achieved by a computer program of the type defined previously, so that the computer program is programmed for implementing the method according to the present invention when the computer program is running on the computer. The computer program thus represents the exemplary embodiments and/or exemplary methods of the present invention as does the method for whose execution the computer program is programmed.

Additional features, possible applications and advantages of the exemplary embodiments and/or exemplary methods of the present invention are derived from the following description of exemplary embodiments of the present invention which are illustrated in the drawings.

### BRIEF DESCRIPTION OF THE DRAWINGS

FIG. 1 shows a schematic diagram of a vehicle having an internal combustion engine and a control unit set up for implementing the method according to the present invention.

FIG. 2 shows a schematic diagram of the chronological sequence of the method according to one possible embodiment of the present invention.

FIG. 3 shows a schematic flow chart of an exemplary embodiment of the method according to the present invention.

### DETAILED DESCRIPTION

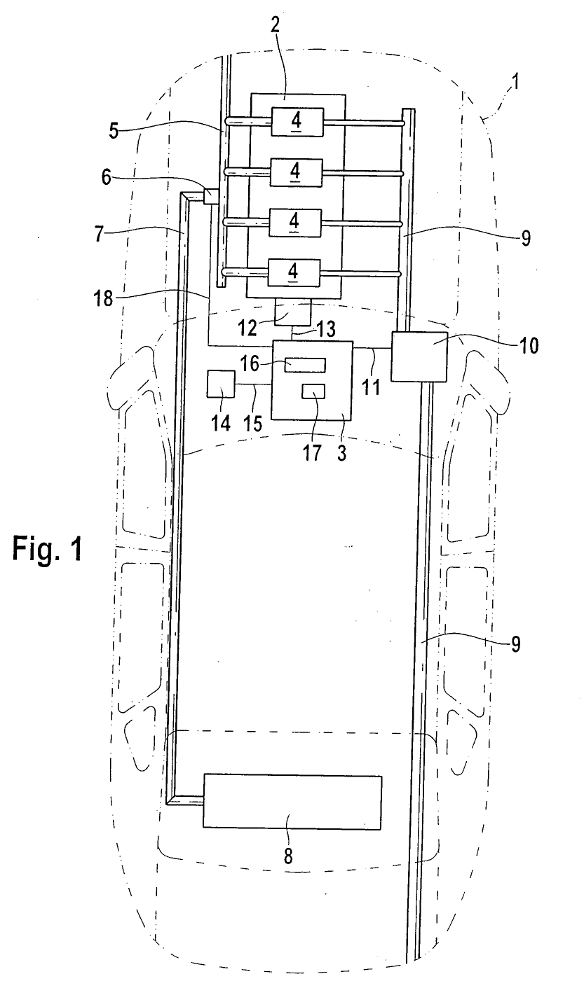

FIG. 1 shows in a highly schematized form a vehicle 1 which includes an internal combustion engine 2 and a control unit 3. Internal combustion engine 2 has cylinders 4, which are connected to an intake manifold 5 and an exhaust system 9. A fuel injector 6 is provided in intake manifold 5 and is connected via a fuel line 7 to a fuel tank 8. Fuel injector 6 is connected to control unit 3 via a signal line 18.

Exhaust system 9 includes an exhaust purification system, e.g., a catalytic converter 10. A sensor for measuring the quality of the exhaust, e.g., a lambda sensor (not shown), is provided in exhaust system 9 and connected via a signal line 11 to a control unit 3.

Internal combustion engine 2 is provided with an electric motor 12. Electric motor 12 may also be part of a hybrid drive in particular. Electric motor 12 is connected to control unit 3 by a signal line 13.

Vehicle 1 also includes a pedal value sensor 14, which is also connected to control unit 3 by a signal line 15.

Control unit 3 includes a processor 16 and a memory element 17. Memory element 17 may be designed as a RAM or a ROM, for example. Memory element 17 may also be designed as a flash memory or as an optical and/or magnetic memory medium. For example, a computer program programmed for performing the method according to the present invention is stored in memory element 17.

Control unit 3 is suitable for controlling and regulating the operation of internal combustion engine 2. Control unit 3 is programmed for implementing the method according to the present invention in particular.

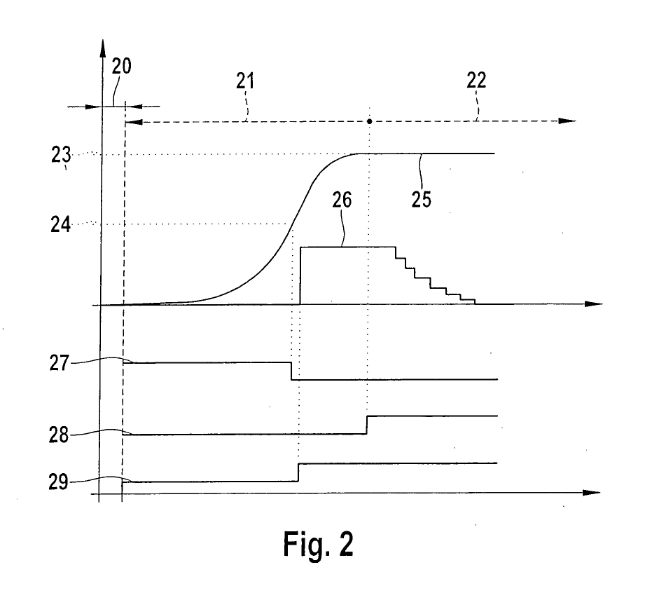

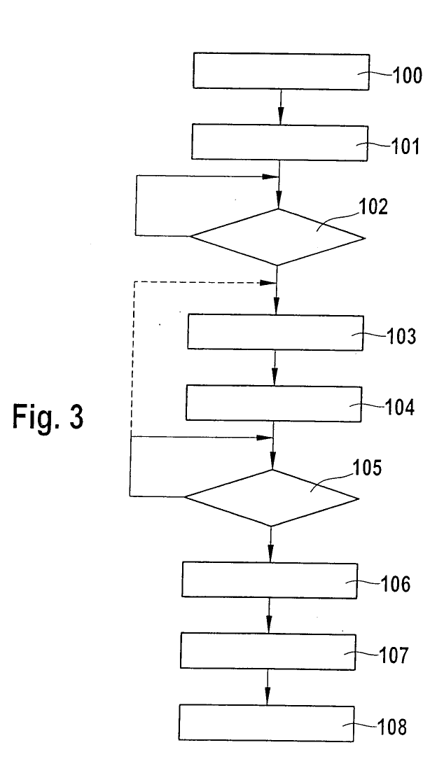

Cooperation of the individual components of vehicle 1 shown in FIG. 1 is described on the basis of the embodiments of the method according to the present invention illustrated in FIGS. 2 and 3.

FIG. 2 shows first a possible chronological chart for implementation of the method according to the present invention. The embodiment shown here as an example includes phases of the method, i.e., shut-down phase 20, drag phase 21 and combustion phase 22.

After the end of shut-down phase 20 and at the start of drag phase 21, rotational speed 25 of internal combustion engine 2 is increased by electric motor 12 until reaching target speed 23. During the drag phase, the engine control is brought to and/or operated in a state resembling coasting operation of internal combustion engine 2. If starting speed 24 is reached or exceeded when speed 25 is increased, then first there is no injection—as would occur in the methods known from the related art and as represented by starting condition 27 in FIG. 2. Instead, an extended starting condition is activated, describing the functionality of a start while driving and thus a reinstatement functionality. Extended starting condition 29 thus describes the state of affairs in which starting condition 27 has already occurred, i.e., minimal starting speed 24 has already been reached, but fuel metering, i.e., injection, has not yet been enabled.

After activation of extended start condition 29, a mixture enrichment 26 is determined. This may be set at the maximum possible value, for example. However, it is advantageous here to detect prevailing operating parameters and allow a highly exhaust-optimized mixture enrichment 26 on the one hand and the quickest possible buildup of a wall film on the other hand on the basis of the operating parameters thereby ascertained.

However, if a complete wall film reduction is to be expected on the basis of drag phase 21, e.g., because drag phase 21 lasts a particularly long period of time or target speed 23 is selected to be particularly high, then it is possible to provide for mixture enrichment 26 to always be set at the maximum level. However, it is advantageous to ascertain mixture enrichment 26 as a function of the duration of shut-down phase 20 to thereby take into account the cooling of the combustion chamber and the resulting reduction in combustion efficiency.

Finally, injection enabling 28 during combustion phase 22 occurs through suitable triggering of fuel injector 6 by control unit 3 via signal line 18. In the next operating cycles, mixture enrichment 26 is reduced by a fixedly predetermined amount per operating cycle or by a dynamically ascertained amount, either immediately or with a time lag, until the wall film is built up completely.

FIG. 3 shows a schematic flow chart of an exemplary embodiment of the method according to the present invention. The method starts in a step 100 in which a start demand is detected. A start demand may be initiated by a driver or generated automatically in a transition from a stop phase to a start phase during start-stop operation of internal combustion engine 2.

The start demand detected causes the transition from shut-down phase 20 to drag phase 21 in one step 101 in which electric motor 12 is activated first.

A check is performed in a step 102 to ascertain whether speed 25 has reached or exceeded starting speed 24. If this is the case, then starting condition 27, which describes the starting method known from the related art, is concluded.

In a step 103, prevailing operating parameters are then detected. The prevailing operating parameters describe, for example, a temperature of internal combustion engine 2 or a prevailing torque demand transmitted from pedal value sensor 14 via signal line 15 to control unit 3.

In a step 104, mixture enrichment 26 is determined within extended starting condition 29 as a function of the prevailing measured operating parameters. Mixture enrichment 26 is designed here so that the wall film is built up as rapidly as possible and nevertheless exhaust-optimized combustion is possible with the start of combustion at the beginning of combustion phase 22.

A check is performed in a step 105 to ascertain whether target speed 23 has been reached. If this is not the case, the check is repeated. It is also conceivable for the program to branch back to step 103 and detect the prevailing operating parameters again and/or to determine a prevailing mixture enrichment 26 in step 104.

If target speed 23 has been reached, injection enabling 28 takes place in step 106, representing the transition from drag phase 21 to combustion phase 22.

In a step 107, mixture enrichment 26 is reduced as a function of the prevailing measured operating parameters or of a predetermined engine characteristics map, so that the wall film is still built up completely and exhaust-optimized combustion is possible. The effect of the wall film that has already been built up is taken into account here with regard to the prevailing combustion. In particular, a prevailing torque demand may also be taken into account here.

This method ends in a step 108, in which the wall film is built up completely and mixture enrichment 26, which is provided for buildup of the wall film, has been reduced completely.

If internal combustion engine 2 is operable in a coasting phase, e.g., during a coasting shutdown, then the method according to the present invention may be implemented in a particularly efficient manner if a basic reinstatement functionality that is already present is used here. The method according to the present invention is then based on mixture enrichment 26, which is provided for a successful reinstatement after a coasting phase. Therefore, the method according to the present invention is particularly simple to implement on the one hand, while on the other hand it is implementable in a particularly exhaust-optimized manner because many of the parameters needed in implementation of the method according to the present invention have already been detected and analyzed for the basic reinstatement functionality.

In drag phase 21, internal combustion engine 2 is put in a state resembling that of coasting mode by electric motor 12 which is particularly strong, such as the motor used with a hybrid drive, for example, and the altered engine control, i.e., drive control, associated with this. If starting speed 24 is exceeded, the starting method characterized by starting condition 27 and known from the related art is reset after reaching starting speed 24 without triggering actuators of internal combustion engine 2, in particular without enabling the injection, and the reinstatement functionality which is provided for control of the hybrid drive anyway is started by an extended starting condition 29. Now the method may begin with the basic reinstatement functionality and injection enabling 28 may be possible as soon as target speed 23 has been reached.

Modifications of the method are of course conceivable. For example, the method may be implemented completely without any prior determination of starting speed 24 and/or starting condition 27. Instead, a speed above which mixture enrichment 26 is determined may be preselected. In this case, the rotational speed may be predetermined in such a way that enough time is available to reliably determine mixture enrichment 26.

What is claimed is:

1. A method for starting an internal combustion engine, the method comprising:
activating an electric motor after a shut-down phase, and the internal combustion engine is brought to a starting speed by the electric motor;
bringing the internal combustion engine to a target speed by the electric motor in a drag phase, the target speed being higher than the starting speed and at least approximately corresponding at least to an idling speed;
determining a mixture enrichment after exceeding the starting speed; and
performing fuel metering, taking into account the determined mixture enrichment after reaching the target speed in a combustion phase.

2. The method of claim 1, wherein the mixture enrichment is determined as a function of one of a measured duration of the shut-down phase, a measured duration of the drag phase, the target speed, and a measured temperature.

3. The method of claim 1, wherein the mixture enrichment is determined as a maximum possible value.

4. The method of claim 1, wherein the mixture enrichment is determined as a function of a prevailing torque demand.

5. The method of claim 1, wherein the mixture enrichment is reduced in the combustion phase one of continuously and in increments.

6. The method of claim 5, wherein the mixture enrichment is reduced, taking into account one of the prevailing value of the mixture enrichment, the target speed, a measured prevailing speed, a measured duration of the combustion phase, a measured prevailing torque demand, and a measured temperature of the internal combustion engine.

7. The method of claim 1, wherein the target speed is determined as a function of one of a prevailing vehicle electrical system voltage, a prevailing torque demand, a measured temperature of the internal combustion engine, and a measured duration of the shut-down phase.

8. The method of claim 1, wherein the target speed is higher than an idling speed.

9. The method of claim 1, wherein the internal combustion engine is operable in a coasting phase and enrichment of the mixture is performed in a reinstatement phase after the coasting phase, and wherein the mixture enrichment is determined in the same manner as the enrichment of the mixture during the reinstatement phase.

10. A control unit for controlling or regulating an internal combustion engine, the internal combustion engine being associated with an electric motor which is activatable after a shut-down phase and which brings the internal combustion engine to a starting speed, the control unit comprising:
an arrangement to start the internal combustion engine by performing the following:
activating the electric motor after a shut-down phase, and the internal combustion engine is brought to a starting speed by the electric motor;
bringing the internal combustion engine to a target speed by the electric motor in a drag phase, the target speed being higher than the starting speed and at least approximately corresponding at least to an idling speed;
determining a mixture enrichment after exceeding the starting speed; and
performing fuel metering, taking into account the determined mixture enrichment after reaching the target speed in a combustion phase.

11. An internal combustion engine system which is associated with an electric motor which is activatable after a shut-down phase, and which brings the internal combustion engine to a starting speed, comprising:
a control arrangement to start the internal combustion engine by performing the following:
activating the electric motor after a shut-down phase, and the internal combustion engine is brought to a starting speed by the electric motor;
bringing the internal combustion engine to a target speed by the electric motor in a drag phase, the target speed being higher than the starting speed and at least approximately corresponding at least to an idling speed;
determining a mixture enrichment after exceeding the starting speed; and
performing fuel metering, taking into account the determined mixture enrichment after reaching the target speed in a combustion phase.

12. The internal combustion engine of claim 11, wherein a hybrid drive is provided by cooperation of the internal combustion engine and the electric motor.

13. A computer readable medium having a program that is executable by a processor arrangement in a control unit, comprising:
program code for controlling or regulating an internal combustion engine, the internal combustion engine being associated with an electric motor which is activatable after a shut-down phase and which brings the internal combustion engine to a starting speed, by performing the following:
activating the electric motor after a shut-down phase, and the internal combustion engine is brought to a starting speed by the electric motor;
bringing the internal combustion engine to a target speed by the electric motor in a drag phase, the target speed being higher than the starting speed and at least approximately corresponding at least to an idling speed;
determining a mixture enrichment after exceeding the starting speed; and
performing fuel metering, taking into account the determined mixture enrichment after reaching the target speed in a combustion phase.

14. The computer readable medium of claim 13, wherein the computer program is stored in a memory element assigned to the processor arrangement, the memory element including one of a random-access memory (RAM), a read-only memory (ROM), a flash memory, an optical memory medium and a magnetic memory medium.
